(19) United States
(12) Patent Application Publication
(10) Pub. No.: US 2014/0148206 A1
(43) Pub. Date: May 29, 2014

(54) METHOD FOR INFORMATION ACQUISITION AND MOBILE PHONE USING THE SAME

(71) Applicant: TENCENT TECHNOLOGY (SHENZHEN) COMPANY LIMITED, Shenzhen City (CN)

(72) Inventors: WEN-JUN GAO, Shenzhen City (CN); MING HE, Shenzhen City (CN); SHI ZHEN, Shenzhen City (CN); LEI CHEN, Shenzhen City (CN); LI WAN, Shenzhen City (CN); WEI-ZHENG SHEN, Shenzhen City (CN)

(73) Assignee: TENCENT TECHNOLOGY (SHENZHEN) COMPANY LIMITED, Shenzhen City (CN)

(21) Appl. No.: 14/167,992

(22) Filed: Jan. 29, 2014

Related U.S. Application Data
(63) Continuation of application No. PCT/CN2012/080652, filed on Aug. 28, 2012.

(30) Foreign Application Priority Data
Nov. 16, 2011 (CN) 201110363204.8

(51) Int. Cl. H04W 4/12

(52) U.S. Cl. CPC H04W 4/12
USPC 455/466

(57) ABSTRACT

The present invention discloses a method for information acquisition and a mobile phone using the method in mobile communication field. The method for information acquisition includes: receiving a notification message sent from a message notification server, wherein the notification message comprises a message reminder content and an uniform resource locator URL of a service page corresponding to a related message; popping up a notification message prompt box on a mobile phone and displaying the message reminder content in the notification message prompt box; and calling, when the message reminder content is being clicked by a user, a browser of the mobile phone for retrieving an information from the service page corresponding to the URL. Through the embodiments of the present invention, users have higher business experience while retrieving information.

### CROSS-REFERENCE TO RELATED APPLICATION

This application is a continuation application of International (PCT) Patent Application No. PCT/CN2012/080652 filed on Aug. 28, 2012, now pending and designating the United States, which also claims benefit of China Patent Application No. 201110363204.8, filed on Nov. 16, 2011. The entirety of the above-mentioned patent applications is hereby incorporated by reference herein and made a part of this specification.

### FIELD OF THE INVENTION

The present invention relates to the mobile communication field, and more particularly to a method for information acquisition through a mobile phone and a mobile phone using the method.

### BACKGROUND OF THE INVENTION

With the widespread use of mobile phones, people have got used to obtain information through mobile phone accessing the Internet. Generally, users obtaining information by using a browser of the mobile phone to access the Internet is realized by entering the URL or using a bookmark.

In the process of the realization of the present invention, the inventors have found that there exists at least the following problems in the prior art: when a user wants to obtain real-time news information in prior art, he/she needs to enter the URL into the browser of the mobile phone or to use a bookmark to access related page for the obtainment of the real-time news information. Thus, the user is not able to access the related information more fast and timely, and accordingly the user may get a lower business experience degrees when accessing information.

### SUMMARY OF THE INVENTION

To improve the business experience while a user is obtaining information, the embodiments of the present invention provide a method for information acquisition through a mobile phone and a mobile using the method. The technical solution as follow.

The present invention provides a method for information acquisition, which includes: receiving a notification message sent from a message notification server, wherein the notification message comprises a message reminder content and an uniform resource locator URL of a service page corresponding to a related message; popping up a notification message prompt box on a mobile phone and displaying the message reminder content in the notification message prompt box; and calling, when the message reminder content is being clicked by a user, a browser of the mobile phone for retrieving an information from the service page corresponding to the URL.

The present invention further provides a mobile phone for information acquisition, which includes a receiver module, a content display module and a first acquisition module. The receiver module is configured to receive a notification message sent from a message notification server, wherein the notification message includes message reminder content and a uniform resource locator URL of a service page corresponding to a related message. The content display module is configured to pop up a notification message prompt box on the mobile phone and display the message reminder content in the notification message prompt box. The first acquisition module configured to call, when the message reminder content is being clicked by a user, a browser of the mobile phone for retrieving information from the service page corresponding to the URL.

The benefit effect brought from the technical solution provided by the embodiments of the present invention is: in the present embodiment, through clicking on the message reminder content in the notification message prompt box, a user can check the specific content of the notification message and thereby obtaining the real-time news or reminder information; thus, the process of getting online is simplified and the user business experience is improved.

### BRIEF DESCRIPTION OF THE DRAWINGS

In order to describe the embodiments of the present invention more clearly, the accompanying drawings required for describing the embodiments are briefly introduced hereinafter. It is apparent that the accompanying drawings are only used for illustrating some of the embodiments of the present invention, and for those ordinarily skilled in the art, further drawings can be realized without additional inventive efforts:

FIG. 1 is a flowchart schematically illustrating a method for information acquisition through a mobile phone in accordance with the first embodiment of the present invention;

FIG. 2 is a flowchart schematically illustrating a method for information acquisition through a mobile phone in accordance with the second embodiment of the present invention;

FIG. 3 is a schematic view of a notification message prompt box provided in the second embodiment of the present invention;

FIG. 4 is a schematic view of a plug-in interface in QQ browser provided in the second embodiment of the present invention;

FIG. 5 is a schematic view of an interface of a mobile-phone QQ report provided in the second embodiment of the present invention;

FIG. 6 is a schematic view of a mobile phone for information acquisition in accordance with the third embodiment of the present invention; and

FIG. 7 is a schematic view of a mobile phone for information acquisition in accordance with the fourth embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention provides a method for obtaining message used in a mobile phone and a mobile phone using the aforementioned method.

Hereinafter, combined with the accompanying drawings of the embodiments of the present invention, the purposes, technical solutions and advantages of the embodiments of the present invention are clearly and fully described.

### First Embodiment

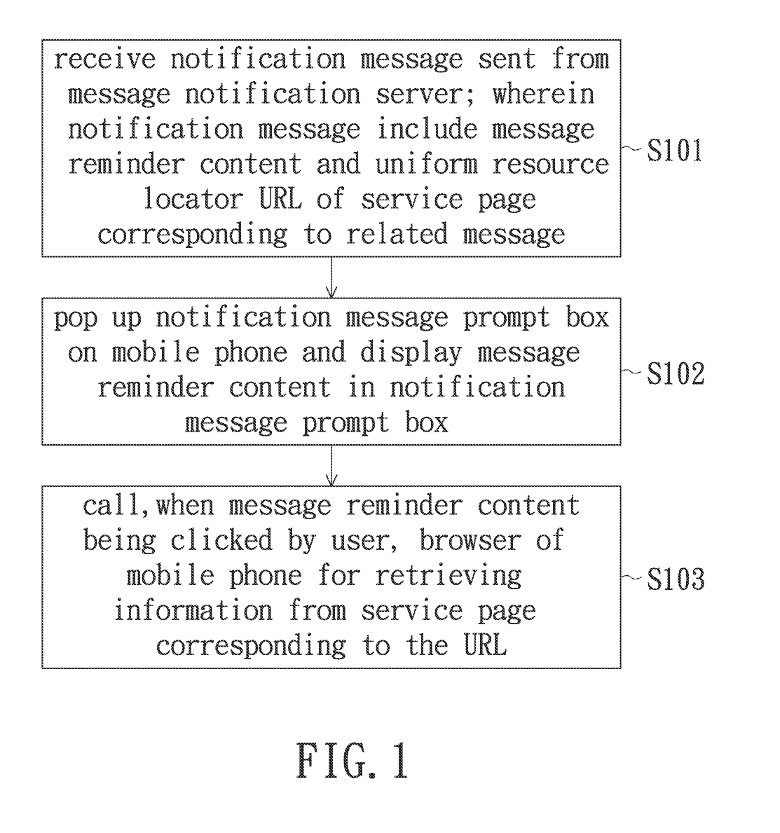

Refer to FIG. 1, which is a flowchart schematically illustrating a method for information acquisition used in a mobile phone in accordance with the first embodiment of the present invention. The main execution body in this embodiment can be a mobile device, in particular, can be a mobile phone, but the present invention is not limited thereto.

The method for information acquisition used in a mobile phone includes steps as follow.

Step S101: receiving a notification message sent from a message notification server; wherein the notification message includes message reminder content and a uniform resource locator URL of a service page corresponding to a related message.

Step S102: popping up a notification message prompt box on the mobile phone and displaying the message reminder content in the notification message prompt box.

Step S103: calling, when the message reminder content is being clicked by a user, a browser of the mobile phone for retrieving information from the service page corresponding to the URL.

In this embodiment, through clicking on the message reminder content in the notification message prompt box, a user can check the specific content of the notification message and thereby obtaining the real-time news or reminder information; thus, the process of getting online is simplified and the user business experience is improved.

### Second Embodiment

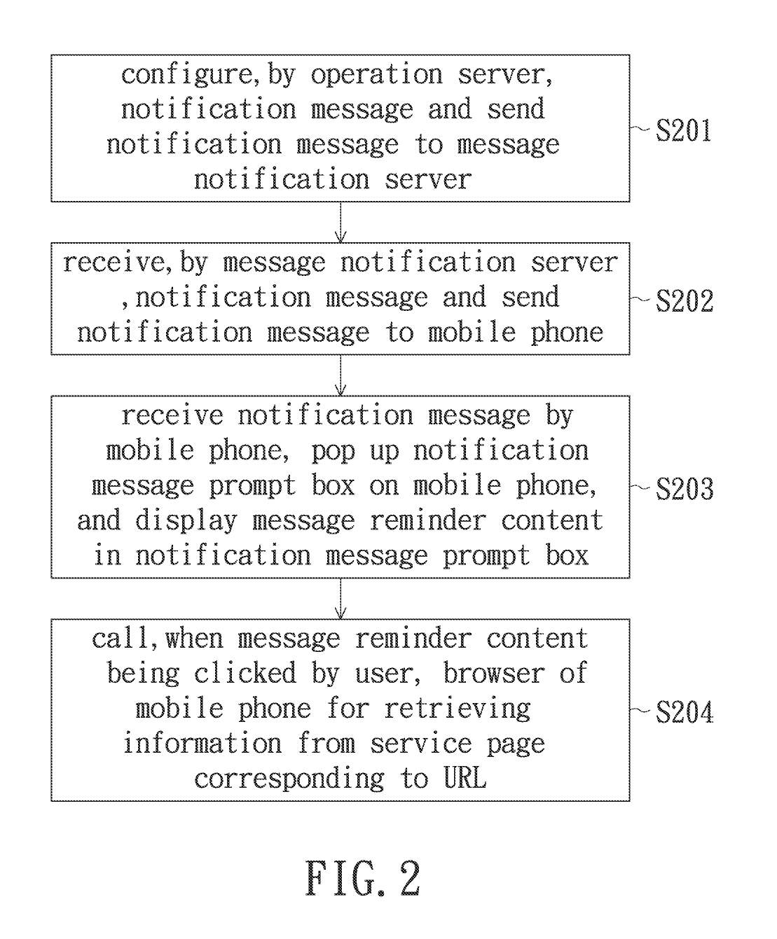

Refer to FIG. 2, which is a flowchart schematically illustrating a method for information acquisition used in a mobile phone in accordance with the second embodiment of the present invention. The method for information acquisition includes steps as follow.

Step S201: configuring, by an operation server, a notification message and sending the notification message to a message notification server.

The notification message includes message reminder content and an URL (Uniform Resource Locator) of a service page corresponding to a related message. The message reminder content and the URL of the service page corresponding to the related message correspond to each other in one-to-one manner.

The message reminder content may be a group of news summaries, breaking news summaries or various categories of news summaries, such as a summary/selection of sport news, a summary/selection of entertainment news, etc. The message reminder content can be configured and sent by the operation server. Or, the message reminder content can be customized by a user through a mobile phone; accordingly, the operation server sends the message reminder content according to customized delivery time and customized content.

Step S202: receiving, by the message notification server, the notification message and sending the notification message to the mobile phone.

Specifically, after receiving the notification message, the message notification server can either forwarded the notification message directly to the mobile phone; or, shorten the length of the URL of the service page corresponding to the related message of the notification message and then send the processed notification message to the mobile phone.

S203: receiving, by the mobile phone, the notification message, popping up a notification message prompt box on the mobile phone, and displaying the message reminder content in the notification message prompt box.

Specifically, in a practice application, the browser receives the notification message when the browser is being used by a user; wherein the notification message includes the message reminder content and the URL of the service page corresponding to the related message of the notification message. Then, after the browser receives the notification message, the notification message prompt box is popped up and the message reminder content is displayed in the notification message prompt box for prompting the user to check the specific content of the notification message by using the browser.

The browser of the mobile phone can be a QQ browser, but the present invention is not limited thereto and no redundant detail is to be given herein.

The notification message prompt box further includes the message reminder content, which is linked to the URL of the service page corresponding to the related message.

Furthermore, the notification message prompt box may further include check and/or cancel buttons; wherein the check button is linked to the URL of the service page corresponding to the related message of the notification message.

Furthermore, the notification message prompt box may further include the name of a buffer location of the notification message. The buffer location of the notification message may include: a plug-in of the browser or a public storage area of the browser. In other words, the notification message is buffered in the plug-in of the browser or the public storage area of the browser. For example, if the browser is QQ browser, the plug-in of the browser is the Q report plug-in, but the present invention is not limited thereto.

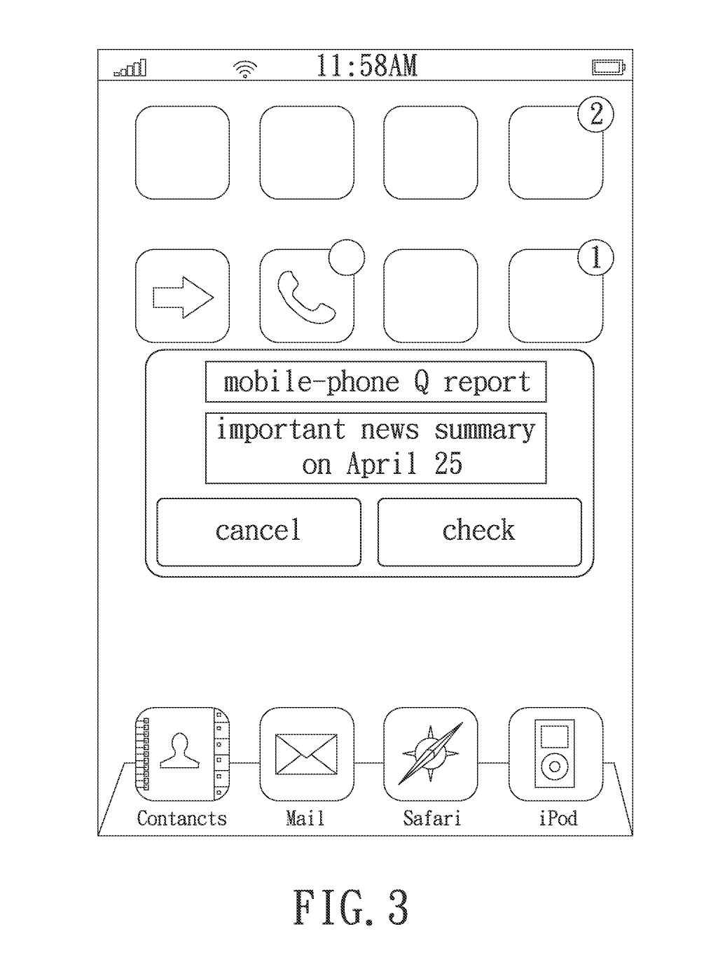

FIG. 3 is a schematic view of an exemplary notification message prompt box provided in the second embodiment of the present invention. As shown, the name of the buffer location of the notification message is: mobile-phone Q report; and the message reminder content is: important news summary on April 25. In addition, the notification message prompt box herein further includes a check button and a cancel button. Thus, through the notification message prompt box, a user is able to be prompted to check the notification message.

S204: calling, when the message reminder content is being clicked by a user, a browser of the mobile phone for retrieving information from the service page corresponding to the URL.

The message reminder content is linked to the URL of the service page corresponding to the related message. Thus, by displaying the service page corresponding to the URL through clicking on the message reminder content linked to the URL, the user can view the specific context of the notification message.

In this embodiment, specifically, the may also link to the URL of the service page corresponding to the related message by clicking on the check button in the notification message prompt box, and check the specific context of the notification message and obtain information by opening the service page corresponding to the URL.

The method for information acquisition in this embodiment further includes: saving the notification message after the notification message is received from the messages notification server.

In a practical application, the browser saves the notification message after the notification message is checked by the user. The notification message may be saved at the buffer location of the notification message, but the present invention is not limited thereto. Specifically, the notification message may be saved in the plug-in of other browsers for the user to check at any time.

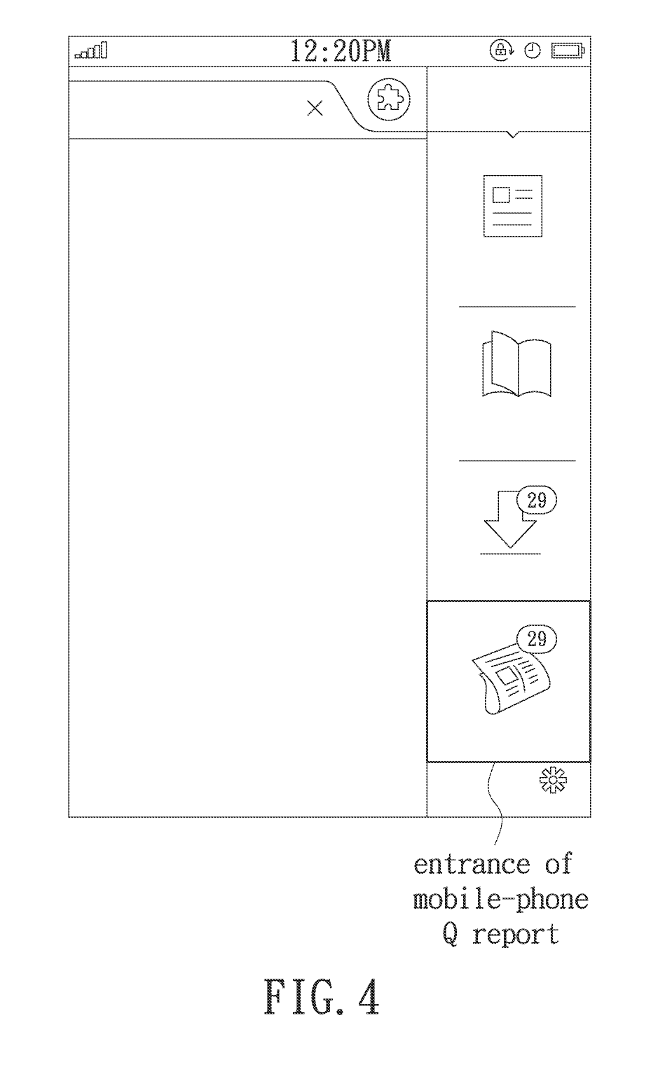

The browser may have a plurality of plug-ins, and the plug-ins may be located in a sidebar of the browser as illustrated in FIG. 4. As shown, the notification message is stored in the mobile-phone Q report plug-in. In addition, the mobile-phone Q report may display the number of the unread notification messages (e.g., 29) thereon. A corresponding page is displayed in response to a click of the mobile-phone Q report.

The mobile phone may further perform managements on the notification message after the notification message is saved thereon.

Still take the mobile-phone Q report in FIG. 4 as an example. Specific managements, such as a delete operation or a check operation, may be performed on the notification message after the mobile-phone Q report is clicked.

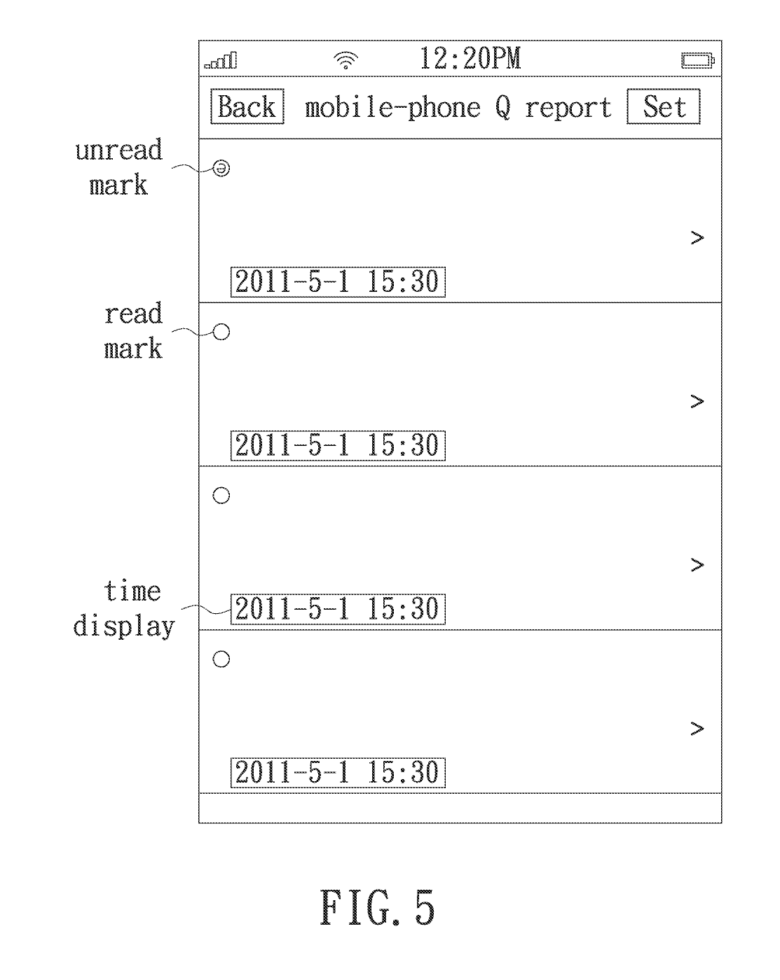

The notification message in the mobile-phone Q report may have two statuses: read and unread, which are distinguished to each other by different identifies. For example, as illustrated in FIG. 5, which is an exemplarily interface of the mobile-phone Q report provided in the second embodiment. As shown, each one of the notification messages in the mobile-phone Q report has time information thereunder for indicating the time of the respective notification message being displayed. Each one of the notification messages also has a right-slide button “>”. Specifically, for a notification message in unread status, the right-slide button “>” is for opening the respective notification message; alternatively, for a notification message in read status, the right-slide button “>” is for deleting the respective notification message. It is understood that the function of the right-slide button “>” is not limited in this embodiment. In addition, the content in the mobile-phone Q report may be refreshed in this embodiment.

In this embodiment, by being capable of being woken up by a notification message configured by an operator through a server, a browser can have a notification function. In addition, through the browser popping up a notification message prompt box after receiving the notification message through clicking on the message reminder content in the notification message prompt box, a user can check the specific content of the notification message and thereby obtaining the real-time news or reminder information; thus, the process of getting online is simplified and the user business experience is improved.

In addition, by implementing the notification feature into the browser, the usage of the browser is significantly increased and the product health degree is improved.

### Third Embodiment

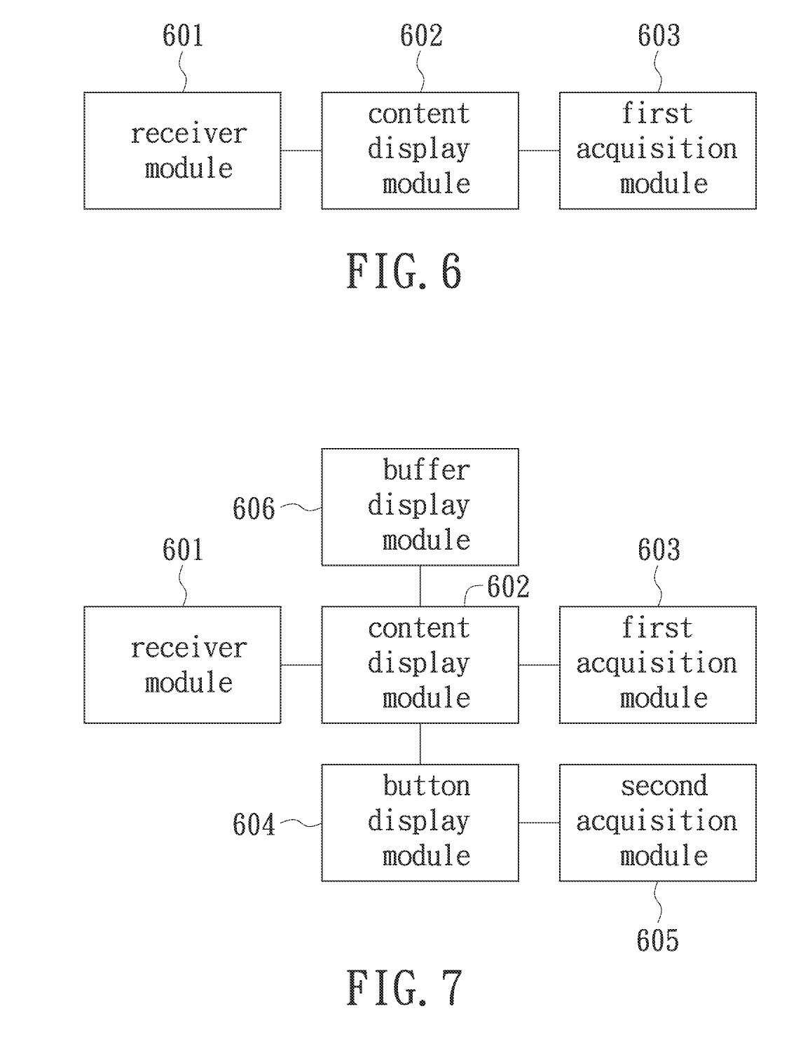

Refer to FIG. 6, which is a schematic view of a mobile phone for information acquisition in accordance with the third embodiment of the present invention. The mobile phone for information acquisition includes a receiver module 601, a content display module 602 and a first acquisition module 603.

The receiver module 601 is configured to receive a notification message sent from a message notification server; wherein the notification message includes message reminder content and a uniform resource locator (URL) of a service page corresponding to a related message.

The notification message is configured by an operation server and then sent to the message notification server.

The content display module 602 is configured to pop up a notification message prompt box on the mobile phone and display the message reminder content in the notification message prompt box.

The notification message prompt box further includes check and/or cancel buttons; wherein the check button is linked to the URL of the service page corresponding to the related message. The notification message prompt box further includes the name of a buffer location of the notification message.

The first acquisition module 603 is configured to call, when the message reminder content is being clicked by a user, a browser of the mobile phone for retrieving information from the service page corresponding to the URL.

A user may also link to the URL of the service page corresponding to the related message by clicking on the check button in the notification message prompt box, and check the specific context of the notification message and obtain information by opening the service page corresponding to the URL.

In this embodiment, through clicking on the message reminder content in the notification message prompt box, a user can check the specific content of the notification message and thereby obtaining the real-time news or reminder information; thus, the process of getting online is simplified and the user business experience is improved.

### Fourth Embodiment

Refer to FIG. 7, which is a schematic view of a mobile phone for information acquisition in accordance with the fourth embodiment of the present invention. The mobile phone for information acquisition includes a receiver module 601, a content display module 602 and a first acquisition module 603. The functions of the receiver module 601, the content display module 602 and the first acquisition module 603 in this embodiment are similar to the receiver module 601, the content display module 602 and the first acquisition module 603 have in the third embodiment, respectively; please refer to the related descriptions in the third embodiment for the detailed information, and no redundant detail is to be given herein.

Based upon including the receiver module 601, the content display module 602 and the first acquisition module 603, the mobile phone for information acquisition in this embodiment further includes a button display module 604 and a second acquisition module 605

The button display module 604 is configured to display check and/or cancel buttons in the notification message prompt box after the notification message prompt box is popped upon the mobile phone.

The second acquisition module 605 is configured to call, when the check button is being clicked by a user, a browser of the mobile phone for retrieving information from the service page corresponding to the URL.

Based upon including the receiver module 601, the content display module 602 and the first acquisition module 603, the device for information acquisition in this embodiment further includes a buffer display module 606; or, based upon including the receiver module 601, the content display module 602, the first acquisition module 603, the button display module 604 and the second acquisition module 605, the device for information acquisition in this embodiment further includes a buffer display module 606.

The buffer display module 606 is configured to display a name of a buffer location of the notification message in the notification message prompt box after the notification message prompt box is popped upon the mobile phone.

Wherein the notification message buffer locations includes: a plug-in of the browser or a public storage area of the browser.

Based upon including the receiver module 601, the content display module 602 and the first acquisition module 603, the device for information acquisition in this embodiment further includes a save module.

The save module is configured to save the notification message after the notification message is received from a messages notification server.

In a practical application, the browser saves the notification message after the notification message is checked by the user. The notification message may be saved at the buffer location of the notification message, but the present invention is not limited thereto. Specifically, the notification message may be saved in the plug-in of other browsers for the user to check at any time.

Furthermore, the device for information acquisition may be further used to perform a management on the notification message.

The management on the notification message, in particular, includes: a delete operation on the notification message or clicking and checking the notification message, etc.

In this embodiment, by being capable of being woken up by a notification message configured by an operator through a server, a browser can have a notification function. In addition, through the browser popping up a notification message prompt box after receiving the notification message through clicking on the message reminder content in the notification message prompt box, a user can check the specific content of the notification message and thereby obtaining the real-time news or reminder information; thus, the process of getting online is simplified and the user business experience is improved.

In addition, by implementing the notification feature into the browser, the usage of the browser is significantly increased and the product health degree is improved.

It is to be noted that the embodiments in the present invention are described in progressive manner. In other words, only the specifications or characteristics different with those in other embodiment are described in the respective embodiment; the same or similar parts among the embodiments can be obtained by cross-reference.

In addition, it is understood that the device embodiment of the present invention has a simpler description due to that most of the specifications or characteristics therein have been described in the method embodiments of the present invention. It is to be noted that the use of “including,” “comprising,” or “having” and variations thereof herein is meant to encompass the items listed thereafter and equivalents thereof as well as additional items. In other words, the embodiments disclosed in the present invention each may further include one or more steps or elements not listed.

The ordinary skill in the art can understand that all or part of the steps in the aforementioned method embodiments can be realized by related hardware instructed by programs, the corresponding programs can be stored in a readable storage medium of computer, such as a ROM, RAM, disk or optical disk, etc.

It is to be understood that the embodiments are used for the illustration of the present invention only, rather than limiting the present invention. It is intended to cover various modifications and similar arrangements included within the spirit and scope of the appended claims which are to be accorded with the broadest interpretation so as to encompass all such modifications and similar structures.

### INDUSTRIAL APPLICABILITY

According to the present invention, through clicking on the message reminder content in the notification message prompt box, a user can check the specific content of the notification message and thereby obtaining the real-time news or reminder information; thus, the process of getting online is simplified and the user business experience is improved.

What is claimed is:

1. A method for information acquisition, wherein the method comprises:
receiving a notification message sent from a message notification server, wherein the notification message comprises a message reminder content and an uniform resource locator URL of a service page corresponding to a related message;
popping up a notification message prompt box on a mobile phone and displaying the message reminder content in the notification message prompt box; and
calling, when the message reminder content is being clicked by a user, a browser of the mobile phone for retrieving an information from the service page corresponding to the URL.

2. The method according to claim 1, wherein the notification message is configured by an operation server and then sent to the message notification server.

3. The method according to claim 1, further comprising, after the step of popping up a notification message prompt box on a mobile phone, steps of:
displaying a check button and/or a cancel button in the notification message prompt box; and
calling, when the check button is being clicked by a user, a browser of the mobile phone for retrieving an information from the service page corresponding to the URL.

4. The method according to claim 1, further comprising, after the step of popping up a notification message prompt box on a mobile phone, a step of:
displaying a name of a buffer location of the notification message in the notification message prompt box.

5. The method according to claim 4, wherein the buffer location of the notification message comprises: a plug-in of the browser or a public storage area of the browser.

6. The method according to claim 1, further comprising, after the step of receiving a notification message sent from a message notification server, a step of:
saving the notification message.

7. A mobile phone for information acquisition, wherein the device comprises:
a receiver module configured to receive a notification message sent from a message notification server, wherein the notification message includes a message reminder content and an uniform resource locator URL of a service page corresponding to a related message;
a content display module configured to pop up a notification message prompt box on the mobile phone and display the message reminder content in the notification message prompt box; and
a first acquisition module configured to call, when the message reminder content is being clicked by a user, a browser of the mobile phone for retrieving information from the service page corresponding to the URL.

8. The mobile phone according to claim 7, further comprising:
a button display module configured to display check and/or cancel buttons in the notification message prompt box after the notification message prompt box is popped upon the mobile phone; and
a second acquisition module configured to call, when the check button is being clicked by a user, the browser of the mobile phone for retrieving information from the service page corresponding to the URL.

9. The mobile phone according to claim 7, further comprising:
a buffer display module configured to display a name of a buffer location of the notification message in the notification message prompt box after the notification message prompt box is popped upon the mobile phone.

10. The mobile phone according to claim 9, wherein the notification message buffer location comprises: a plug-in of the browser or a public storage area of the browser.

11. The mobile phone according to claim 7, further comprising:
a save module configured to save the notification message after the notification message is received from a messages notification server.
